(19) United States
(12) Patent Application Publication
(10) Pub. No.: US 2004/0058824 A1
(43) Pub. Date: Mar. 25, 2004

(54) Additive for oil-based invert drilling fluids

(76) Inventors: Frank Burbach, Willich (DE); Heinz Mueller, Monheim (DE)

Correspondence Address: COGNIS CORPORATION, PATENT DEPARTMENT, 300 BROOKSIDE AVENUE, AMBLER, PA, 19002, US

(21) Appl. No.: 10/470,037

(22) PCT Filed: Jan. 25, 2002
(86) PCT No.: PCT/EP02/00772

(30) Foreign Application Priority Data
Feb. 3, 2001 (DE) 101 04 869.6

(51) Int. Cl. C09K 7/06

(52) U.S. Cl. 507/100

(57) ABSTRACT

An invert drilling fluid composition containing: (a) an oil phase; (b) a water phase; (c) at least one emulsifier; (d) at least one weighting agent; (e) at least one fluid loss additive; (e) at least one electrolyte component containing a mixture of calcium acetate and magnesium acetate; and (g) at least one thickening agent.

This invention relates to invert drilling fluid systems suitable for geological exploration and to the use of certain salts for modifying the rheology of such systems.

It is known that drilling fluids for sinking wells in rock and bringing up the rock cuttings are flowable water- or oil-based systems that are thickened to a limited extent. Oil-based systems are acquiring increasing significance in practice and are used in particular in offshore drilling operations. Oil-based drilling fluids are generally used as so-called invert emulsion muds which consist of a 3-phase system: oil, water and fine-particle solids. Drilling fluids such as these are preparations of the w/o emulsion type, i.e. the aqueous phase is heterogeneously and finely dispersed in the continuous oil phase. A range of additives may be used for stabilizing the system as a whole and for establishing the required performance properties, including in particular emulsifiers and emulsifier systems, weighting agents, fluid loss additives, viscosity adjusters and optionally an alkali reserve. Relevant particulars can be found, for example, in the article by P. A. Boyd et al. entitled “New base oil used in low toxicity oil muds”; Journal of Petroleum Technology, 1985, 137-142. Inorganic salts, preferably calcium chloride dihydrate, are also present, being added to the systems to reduce the osmotic pressure on the formation. If the salt content in the aqueous phase of the invert fluid is too low, the formation can be destabilized through the migration of water from the fluid into the formation. In the opposite case of a relatively high salt concentration in the aqueous phase of the drilling fluid, there is an exchange from the formation into the drilling fluid which prevents the formation from swelling and counteracts destabilization. Further particulars can be found in the publication “Drilling Fluid Optimization”, J. L. Lummus, Penn W II Books, 1986, Chapter 10, of which the disclosure is also part of the present invention. This applies in particular to pages 219 to 224 where the effect of salts in drilling fluid systems is described.

In general, the calcium chloride mentioned above is used to obtained the required salinity. Unfortunately, the high salt content leads to serious corrosion of metal parts of the conveying and drilling equipment. Accordingly, a problem addressed by the invention was to find a way of producing salinity in invert drilling fluids without causing any corrosion. The disposal of cuttings contaminated with conventional drilling fluids is also attended by ecological problems because the drilling fluids contain a high percentage of unwanted chloride.

The disadvantages described above can be avoided by the use of certain salts as substitutes for calcium chloride.

In a first embodiment, the present invention relates to an invert drilling fluid containing

| | |
|---|---|
| a) | a continuous oil phase, |
| b) | a water phase dispersed in the oil phase, |
| c) | at least one emulsifier, |
| d) | at least one weighting agent, |
| e) | at least one fluid loss additive, |
| f) | at least one electrolyte, |
| g) | at least one thickener, |
| h) | optionally other additives, |

the electrolyte f) being a mixture of calcium acetate and magnesium acetate.

The principal constituent of the invert drilling fluid systems according to the invention is the continuous oil phase a) which forms the so-called carrier fluid. Carrier fluids are already known, for example, from earlier Cognis patents/patent applications, cf. in particular Europ an patent applications 0 374 671, 0 374 672, 0 382 070, 0 386 638. Oil phases based on linear olefins are also known to the expert, cf. European patent 0 765 368 A1. Other suitable constituents of the oil phase include water-insoluble, symmetrical or nonsymmetrical ethers of monohydric alcohols of natural or synthetic origin which may contain from 1 to 24 carbon atoms. Drilling fluid systems such as these are the subject of European patent application 0 472 557. In addition, the carbonic acid diesters according to European patent application 0 532 570 are suitable constituents of the oil phase. These compounds may make up both the entire oil phase and also parts thereof. Mixtures of compounds i) to vi) with one another are also possible. However, the carboxylic acid esters corresponding to formula (I) and especially those described in European patents EP 0 374 672 A1 and EP 0 386 636 A1 are particularly preferred. In a particularly preferred embodiment of the teaching according to the invention, the compounds of formula (I) are used in invert drilling fluid emulsions of which the oil phase a) contains esters corresponding to formula (I) in which the substituent R¹ is a C₅₋₂₁ alkyl group, preferably a C₅₋₁₇ alkyl group and more particularly a C₁₁₋₁₇ alkyl group. Particularly suitable alcohols in esters such as these are based on branched or unbranched alcohols containing 1 to 8 carbon atoms, for example on methanol, isopropanol, isobutanol or 2-ethylhexanol. C₁₂₋₁₈ alcohols are also preferred. Particularly preferred esters are saturated C₁₂₋₁₄ fatty acid esters or unsaturated C₁₆₋₁₈ fatty acids with isopropyl, isobutyl or 2-ethylhexanol as the alcohol component. 2-Ethyl octanoate is also suitable. Other suitable esters are acetic acid esters, especially acetates of C₈₋₁₈ fatty alcohols.

Branched esters of type i) as disclosed, for example, in WO 99/33932 (Chevron) or in EP 0 642 561 (Exxon) are also suitable carrier fluids in the process according to the invention. The esters described in those documents are part of the disclosure of the present invention. Mixtures of these preferred esters with one another are also preferred. In addition, the oil phases may contain the above-described components as carrier fluids; alpha-olefins can be particularly preferred mixture constituents. Preferred mixtures such as these are the subject of applicants' EP 0 765 368 A1.

The oil phase a) of the emulsions according to the invention preferably consists of at least 50% by weight of such preferred compounds i) to vi), systems in which 60 to 80% and more particularly 100% by weight of the oil phase consists of compounds i) to vi) or mixtures thereof being particularly preferred. In particularly preferred invert drilling fluids according to the invention, the continuous oil phase a) consists completely or partly of compounds of class i) or alternatively ii). It can be of particular advantage to use mixtures of oil components i) and ii) as sole constituents of the oil phase.

Water (component b) is another compulsory constituent of the described drilling fluid systems. The water is preferably present in the invert emulsions in quantities of at least about 0.5% by weight. In a preferred embodiment, however, the invert emulsions contain at least 5 to 10% by weight of water. It is of advantage to adjust the oil/water ratio (w/w) to certain selected ranges. These are preferably from 90:10 to 50:50 component a) to component b), preferably from 90:10 to 70:30 and more particularly from 80:20 to 70:30.

The water in drilling fluid systems of the type described herein always contains quantities of electrolytes to equalize the osmotic gradient between the drilling fluid and the formation water. According to the invention, mixtures of calcium and magnesium acetate are used instead of the calcium chloride (CaCl₂×2H₂O) or sodium salts normally used. Accordingly, the present invention also relates to the use of a mixture of calcium and magnesium acetate as electrolyte for establishing the salinity of invert drilling fluids.

Preferably, only the electrolyte mixtures according to the invention are added to the drilling fluids according to the invention. In practice, however, calcium and sodium chloride accumulate in the invert drilling fluid through seawater or formation water and through reaction of the alkali reserve lime. The drilling fluids according to the invention contain the mixture of Va and Mg acetate in quantities of preferably 1 to 15% by weight, more preferably 2 to 12% by weight and most preferably 5 to 10% by weight. A preferred embodiment is characterized by the use of Ca and Mg acetate mixtures which contain Ca and Mg ions in a molar ratio of 10:1 to 1:10 and preferably in a molar ratio of 1:1 to 1:10. It has been found to be of advantage for a molar excess of magnesium to be present in the acetate mixtures. A particularly preferred molar ratio between magnesium and calcium is 3:7.

The salts used may be of technical quality. Particular purity is not crucial to the invention. The addition of calcium/magnesium acetate leads a) to a reduction in the corrosion of metal parts with which the drilling fluid comes into contact and b) the cleaning of the cuttings is facilitated by the use of the invert emulsions defined in accordance with the invention.

The invert systems according to the invention may optionally contain other additives as auxiliaries and additives. An alkali reserve is preferably used to keep the pH of the system stable, even in the presence of inflowing acidic gases, such as CO₂ or H₂S. The pH should be kept at least in the mildly alkaline range, preferably between 8.5 and 10 and more particularly between 8.5 and 9.0. Lime is normally used as the alkali reserve and is used in quantities of 0.5 to 10 lb/bbl invert drilling fluid. Depending on the oil phase used, however, this value may have to be significantly reduced in order to suppress unwanted hydrolysis reactions of the oil phase. In that case, it is of advantage to adjust the content of free lime in the drilling fluid to below 2 lb/bbl. Alternatively, protonated amine compounds may also be used as a substitute for the normal alkali reserve. Compounds such as these are described in WO 00/27945, U.S. Pat. No. 5,977,031, U.S. Pat. No. 5,985,800, U.S. Pat. No. 5,909,779, U.S. Pat. No. 5,905,061 and U.S. Pat. No. 5,888,944, of which the disclosure is also part of the present invention. Such systems are free from lime.

Other additives which may be present in the drilling fluids according to the invention are thickeners g), preferably organophilic bentonite. Emulsifiers c) are also used (relevant particulars can be found in the prior art cited above). Fluid loss additives, for example organophilic lignite e), are also among the additives normally used. Weighting agents d) are also typical constituents of invert drilling fluid systems for adjusting their specific gravity to values of 1.2 to 2.5. These densities are necessary for giving the fluid the required buoyancy for cuttings. Barium sulfate (barite) is suitable and is preferably used. Glycols and/or glycerol may also be added to the systems. In addition, dispersion aids, corrosion inhibitors and/or foam inhibitors may also be used. These and other suitable auxiliaries and additives are used in quantities familiar to the expert and in dependence upon the characteristics of the particular well. Particulars can be found in the relevant literature, cf. for example “Manual of Drilling Fluid Technologies”, Baroid/NL Industries Inc., 1979, Chapter 3.

The invert drilling fluids preferably have a plastic viscosity of 10 to 70 mPas and a yield point (YP) of 5 to 60 lb/100 ft². It has also been found that the presence of electrolyte mixture according to the invention in the drilling fluid can effectively influence its rheology, a thickening effect thus being possible. Accordingly, the present invention also relates to the use of a mixture of calcium and magnesium acetate for influencing the rheology of invert drilling fluids.

### EXAMPLES

To test electrolytes in invert drilling fluid systems, the following general formulations were prepared and tested for their rheological properties with different carrier fluids and electrolytes:

TABLE 1

| | W/O | | | | W/O | |
|---|---|---|---|---|---|---|
| | ratio | Density | W/O ratio | Density | ratio | Density |
| | 70/30 | 13.1 lb/gal | 80/20 | 16.7 lb/gal | 90/10 | 18.3 lb/gal |
| Carrier fluid | 0.512 | bbl | 0.474 | bbl | 0.491 | bbl |
| Emulsifier | 12 | lb | 12 | lb | 15 | lb |
| Duratone HT | 6 | lb | 10 | lb | 10 | lb |
| Lime | 1 | lb | 1 | lb | 1 | lb |
| Geltone II | — | lb | 0.75 | lb | 1 | lb |
| Water | 0.22 | bbl | 0.12 | lb | 0.055 | lb |
| Electrolyte | 33 | lb | 18.5 | lb | 8 | lb |
| BaSO₄ | 266 | lb | 470 | lb | 570 | lb |
| OMC 42 | 1 | lb | 3 | lb | — | lb |
| OMC 3 | — | lb | 1 | lb | — | lb |

These systems contain Petrofree® (a Cognis product, ester of saturated C₁₂₋₁₆ monocarboxylic acids with 2-ethylhexanol) or Rilanit EHO (a Cognis product, ester of unsaturated C₁₈ monocarboxylic acids with 2-ethylhexanol) as carrier fluid. The emulsifier used was EZ Mul NTE (a Baroid product). Duratone II (a Baroid product) is an organophilic lignite which is used as a fluid loss additive. Geltone is an organophilic bentonite (a Baroid product). OMC 3 and OMC 42, Baroid products, are added to the drilling fluids as dispersion aids.

The rheological properties were measured after ageing for 16 hours at 250° F. in a roller oven (Fann 35 SR 12) and are shown in Tables 2 to 4 below. AHR and BHR stand for “after hot rolling” and “before hot rolling” respectively.

Table 2.

TABLE 2

| | |
|---|---|
| Density | 16.7 lb/gal |
| Oil/water ratio | 80/20 |
| Oil phase in Examples A and B: | |
| Petrofree ® | |
| in Examples C and D: | |
| Rilanit EHO | |

The measurements were carried out with the electrolyte calcium chloride dihydrate in the case of A) and C) and with the calcium/magnesium acetate mixture according to the invention (molar ratio of Ca to Mg 3:7) in the case of B) and D).

| | A | | B | | C | | D | |
|---|---|---|---|---|---|---|---|---|
| | BHR | AHR | BHR | AHR | BHR | AHR | BHR | AHR |
| PV | 63 | 65 | 51 | 51 | nb | nb | nb | 105 |
| YP | 62 | 63 | 15 | 19 | nb | nb | nb | 78 |
| Gels 10/10 | 26/29 | 23/23 | 4/8 | 5/7 | 92/83 | 62/55 | 67/65 | 26/31 |

nb: measurement not possible due to excessive viscosity

nb: measurement not possible due to excessive viscosity

It can be seen that the use of the salt mixtures according to the invention improves the rheology of the drilling fluids after ageing in relation to conventional systems.

TABLE 3

| | |
|---|---|
| Density | 18.3 lb/gal |
| Oil/water ratio | 90/10 |
| Oil phase in Examples A and B: | |
| Petrofree ® | |
| in Examples C and D: | |
| Rilanit EHO | |

| | A | | B | | C | | D | |
|---|---|---|---|---|---|---|---|---|
| | BHR | AHR | BHR | AHR | BHR | AHR | BHR | AHR |
| PV | 66 | 62 | 57 | 55 | nb | nb | 115 | 105 |
| YP | 41 | 31 | 19 | 10 | nb | nb | 62 | 42 |
| Gels 10/10 | 18/19 | 13/15 | 7/11 | 4/6 | 45/40 | 36/34 | 30/33 | 17/21 |

nb: measurement not possible due to excessive viscosity

nb: measurement not possible due to excessive viscosity

TABLE 4

| | |
|---|---|
| Density | 13.1 lb/gal |
| Oil/water ratio | 70/30 |
| Oil phase in Examples A and B: | |
| Petrofree ® | |
| in Examples C and D: | |
| Rilanit EHO | |

| | A | | B | | C | | D | |
|---|---|---|---|---|---|---|---|---|
| | BHR | AHR | BHR | AHR | BHR | AHR | BHR | AHR |
| PV | 60 | 44 | 37 | 33 | nb | nb | nb | 78 |
| YP | 104 | 65 | 45 | 29 | nb | nb | nb | 118 |
| Gels 10/10 | 47/47 | 26/28 | 16/21 | 9/11 | 87/78 | 51/48 | 62/64 | 41/44 |

nb: measurement not possible due to excessive viscosity

nb: measurement not possible due to excessive viscosity

1. An invert drilling fluid containing
a) a continuous oil phase,
b) a water phase dispersed in the oil phase,
c) at least one emulsifier,
d) at least one weighting agent,
e) at least one fluid loss additive,
f) at least one electrolyte,
g) at least one thickener,
h) optionally other additives,
characterized in that the electrolyte f) is a mixture of calcium acetate and magnesium acetate.

2. An invert drilling fluid as claimed in claim 1, characterized in that the continuous oil phase a) is formed completely or partly from the group of compounds flowable and pumpable at 0 to 5° C. selected from the following classes:
i) carboxylic acid esters corresponding to formula (I):
R′—COO—R″ (I)
where R′ is a saturated or unsaturated, linear or branched C₅₋₂₃ alkyl group and R″ is a C₁₋₂₂ alkyl group which may be saturated or unsaturated, linear or branched,
ii) linear or branched C₈₋₃₀ olefins,
iii) water-insoluble, symmetrical or nonsymmetrical ethers of monohydric alcohols of natural or synthetic origin which may contain 1 to 24 carbon atoms,
iv) water-insoluble alcohols corresponding to formula (II):
R′″−OH (II)
where R′″ is a saturated, unsaturated, linear or branched C₈₋₂₄ alkyl group,
v)
vi) carbonic acid diesters.

3. An invert drilling fluid as claimed in claims 1 and 2, characterized in that the continuous oil phase a) is formed completely or partly from compounds of class i).

4. An invert drilling fluid as claimed in claims 1 to 3, characterized in that the continuous oil phase a) is formed completely or partly from compounds of class ii).

5. An invert drilling fluid as claimed in claims 1 to 4, characterized in that the continuous oil phase is formed completely from mixtures of classes i) and ii).

6. An invert drilling fluid as claimed in claims 1 to 5, characterized in that the ratio by weight of component a) to component b) is in the range from 90:10 to 50:50, preferably in the range from 90:10 to 70:30 and more particularly in the range from 80:20 to 70:30.

7. An invert drilling fluid as claimed in claims 1 to 6, characterized in that it contains lime as an additional additive.

8. An invert drilling fluid as claimed in claims 1 to 6, characterized in that it contains protonated amines as an additional additive but no lime.

9. An invert drilling fluid as claimed in claims 1 to 7, characterized in that it has a plastic viscosity of 10 to 70 mPas and a yield point YP of 5 to 60 lb/100 ft².

10. An invert drilling fluid as claimed in claims 1 to 9, characterized in that it contains the electrolyte f) in quantities of 1 to 15% by weight, preferably in quantities of 2 to 12% by weight and more particularly in quantities of 5 to 10% by weight, based on the invert drilling fluid as a whole.

11. An invert drilling fluid as claimed in claims 1 to 10, characterized in that the electrolyte f) contains calcium and magnesium ions in a molar ratio of 10:1 to 1:10.

12. The use of a mixture of calcium and magnesium acetate as an electrolyte for adjusting the salinity of invert drilling fluids.

13. The use of a mixture of calcium and magnesium acetate for influencing the rheology of invert drilling fluids.
